(19) United States
(12) Patent Application Publication
(10) Pub. No.: US 2011/0270828 A1
(43) Pub. Date: Nov. 3, 2011

(54) PROVIDING SEARCH RESULTS IN RESPONSE TO A SEARCH QUERY

(75) Inventors: Manik Varma, Bangalore (IN); Vidit Jain, Amherst, MA (US)

(73) Assignee: Microsoft Corporation, Redmond, WA (US)

(21) Appl. No.: 12/769,672

(22) Filed: Apr. 29, 2010

(51) Int. Cl. G06F 17/30

(52) U.S. Cl. 707/728; 707/E17.014

(57) ABSTRACT

A method for providing search results in response to a search query is provided. The method includes receiving the search query from a user and generating a plurality of results in response to the search query. The plurality of results may be ranked according to an original relevancy score. The method further includes generating a click relevancy score for each of the plurality of results and re-ranking the plurality of results according to the click relevancy score.

### BACKGROUND

In keyword based image searches, a search engine returns a list of images in response to a user's search query. Typically, such a list is ranked, by a ranker, in decreasing order of relevancy to the query. Generally, current ranking algorithms may be learned from training data, which have been annotated by human experts. To this end, a prediction model may be learned across all types of queries within a vertical. For example, for a certain query, a set of images may be taken to a human expert to determine the relevancy of those images to the query. The human expert may give each image a rank, or an ordinal score, thereby creating a set of training data. From the training data, certain algorithms may be used to create a ranker for use across all queries.

Certain problems can arise, however, using the current methods mentioned above. For instance, human experts can often make mistakes in trying to determine a user's intention with regard to a query. Also, queries can often have multiple meanings, e.g. “night train,” which can refer to a train at night or to a particular brand of a motorcycle.

### SUMMARY

Described herein are implementations of various technologies for re-ranking search results in response to a search query. In one implementation, the search results may be image search results generated in response to an image search query. Generally, various technologies described herein contemplate re-ranking a previously ranked list of results based on the predicted number of user clicks each result may receive in response to the query. It should be noted that for certain results, the number of clicks those results have received in response to a search query may be highly correlated to the relevancy of the results to search query.

At a high level, various technologies described herein contemplate three steps to perform the re-ranking. First, a baseline ranker or default ranker may be used to generate an original relevancy score for each search result in response to a search query. The baseline ranker may then rank each search result according to its original relevancy score. The baseline ranker may be referred to any ranking system employed by current search engines such as Bing, Google, Yahoo, and/or the like. Next, a predicted number of clicks may be estimated for each result and may be incorporated into the determination of a click relevancy score for each result. Finally, the results may be re-ranked according to their click relevancy scores.

In estimating the predicted number of clicks for each search result of a query, various supervised learning algorithms may be employed. Such algorithms may include, but are not limited to regression, ordinal regression, and classification. In one implementation, features of each search result may be compared with similar features of a set of training data composed of previously clicked images for the query. In another implementation, the specific features used for the comparison may be selected according to a dimensionality reduction algorithm so as to prevent including in the estimation clicked images that have no predictive weight for unclicked images. The predicted number of clicks for a search result may then be linearly combined with its original relevancy score to determine the click relevancy score.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for providing search results in response to a search query in accordance with one or more implementations of various techniques described herein.

### DETAILED DESCRIPTION

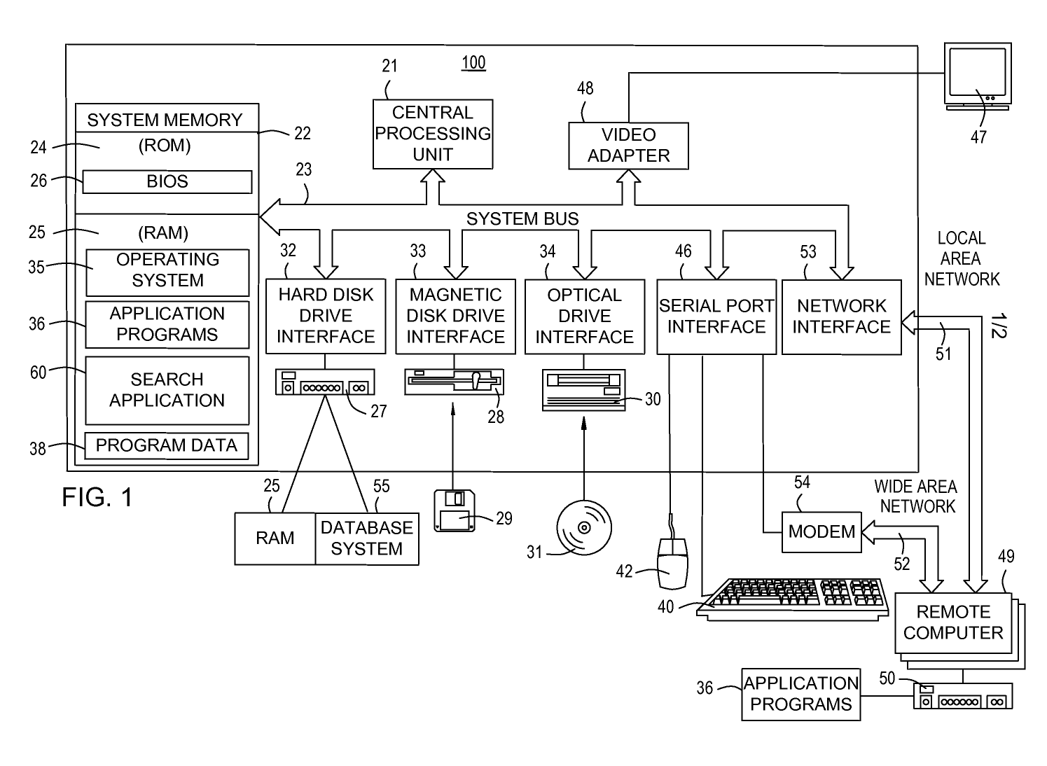

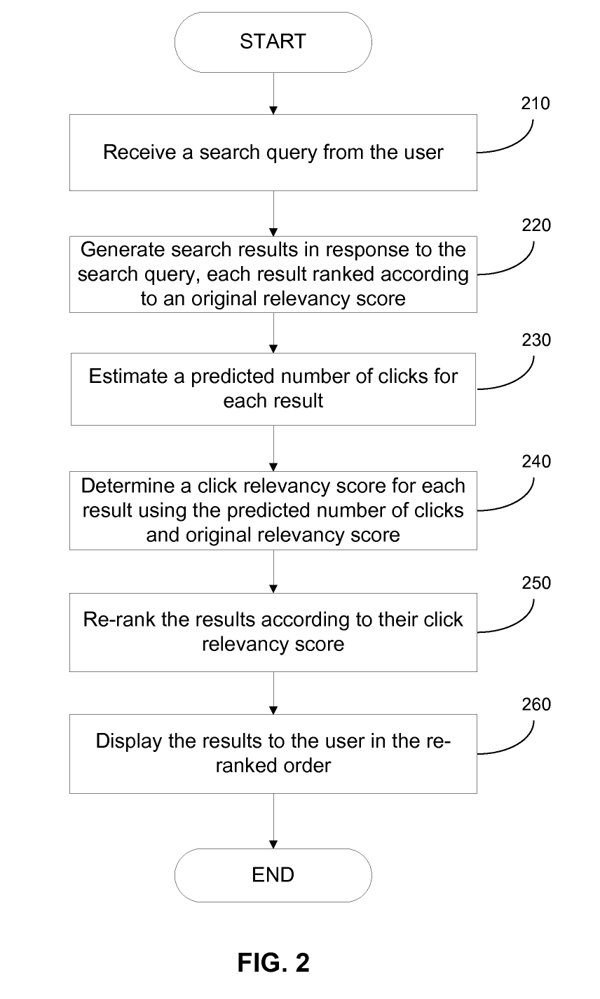

In general, one or more implementations described herein are directed to re-ranking query-specific search results according to click data. Various techniques for re-ranking query-specific search results according to click data will be described in more detail with reference to FIGS. 1-2.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 27, magnetic disk 29, optical disk 31, ROM 24 or RAM 25, including an operating system 35, one or more application programs 36, a search application 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The search application 60 may be configured to generate search results in response to search queries submitted by users on a remote computer 49. Furthermore, the search application 60 may be configured to carry out the steps to re-rank search results according to the method more fully described with reference to FIG. 2 described below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers 49. The logical connections may be any connection that is commonplace in offices, enterprise-wide computer networks, intranets, and the Internet, such as local area network (LAN) 51 and a wide area network (WAN) 52. When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method for providing search results in response to a search query in accordance with one or more implementations of various techniques described herein. The following description of method 200 is made with reference to computing system 100 of FIG. 1. It should be understood that while the method 200 indicates a particular order of execution of the operations, in some implementations, certain portions of the operations might be executed in a different order. Furthermore, method 200 may operate under the assumption that the number of clicks a result has received in response to a search query may be highly correlated to the relevancy of the result to the search query.

At step 210, a search application 60 may receive a search query from a user. In one implementation, the search query may be an image search query in which the search application 60 displays search results to the user in the form of images. For instance, if a user were to submit the word “dog” as a search query, the search application may cause an image or images of dogs to be displayed to the user, rather than textual results.

At step 220, the search application 60 may generate search results in response to the user's search query, each result ranked according to an original relevancy score. An original relevancy score for a result may refer to a numerical value representing the result's relevancy to the search query as determined by a baseline ranker. The baseline ranker may be any algorithm, formula, procedure, etc. employed to rank or list the search results in order of relevancy (e.g., decreasing order of relevancy). In one implementation, the baseline ranker may be any of the default rankers currently used by well-known search engines, including, but not limited to, Bing, Google, and/or Yahoo. Furthermore, various technologies described herein may assume that the baseline ranker may be incapable of accepting feedback from a user to reevaluate its generated ranked list.

Typically, a baseline ranker may be learned or developed by presenting a search query and a set of documents or results to a human “expert.” The human expert may in turn judge the relevance of each document to the search query according to a numerical scale (e.g., a scale of 1-5, 5 being very relevant and 1 being not relevant.) Furthermore, the expert may provide a series of similar judgments for other search queries and other search results until an adequate data set has been created. From this data set, a baseline ranker may be learned such that the baseline ranker may give rankings to search results approximating the rankings the expert would have given. However, determining an original relevancy score for a result using such a baseline ranker may produce certain inaccuracies. Indeed, irrespective of his/her qualifications, a human expert may nevertheless be prone to making mistakes in judging a user's intent when submitting a search query. For example, an expert may judge an image of a motorcycle as irrelevant to the query “night train” despite the fact that most users who submit this query may be searching for a particular model of a Harley-Davidson motorcycle. Many other such words with multiple meanings also exist, which may compound the difficulties associated with baseline rankers.

Each result generated in step 220 may be associated with one or more features. The features may correspond to pieces of data describing attributes or characteristics associated with a result, a result's parent document, other metadata, and the like. As used herein, a parent document of a result may refer to a document to which the result belongs. Furthermore, features may include both textual features and visual features. Textual features may be categorized into query-independent textual features and query-dependent textual features. Query-independent textual features such as PageRank and/or the like may be designed to capture the importance and reliability of a result's parent document, irrespective of the specific query submitted. Query-dependent textual features may include attributes such as the title of a result's parent document, the match between the query and the title, and/or other similar features that may depend on the particular query. Visual features may include attributes such as histograms of color gradients, color channels, and/or the like.

Before commencing discussion of step 230 through step 260, it may be useful to define some general terms. In one implementation, each search result for a search query may be annotated with “click data” representing the number of times the result has been clicked in the past, by any user, in response to the search query. Search results that have been clicked at least once in response to the search query are herein referred to as “clicked results.” Conversely, search results that have been clicked zero times in response to the search query are herein referred to as “unclicked results.” Thus, a search result for a particular search query may be either a clicked result or an unclicked result.

At step 230, the search application 60 may estimate a predicted number of clicks for each search result. In one implementation, the search application 60 may only estimate a predicted number of clicks for the first 1000 results generated. As described in more detail with reference to steps 240-260 below, the estimate may be used to determine a click relevancy score for each search result, and the results may then be re-ranked according to the click relevancy scores. Such an approach may be in contrast to the notion of simply re-ranking results according to only their actual number of clicks.

Indeed, determining a search result's click relevancy score based only on its actual number of clicks may produce certain inaccuracies. For example, it is generally well known in the art that users may tend to click results near the top of a displayed result list much more frequently than results towards the middle or bottom of the list. Thus, when calculating the click relevancy scores for results using only their actual number of clicks, the results with the most clicks may create a self-referencing loop. That is, highly clicked results may always be deemed to have relatively high relevancy, and may therefore be displayed near the top of a result list. Consequently, these same results may keep receiving the most clicks due to their relatively high visibility to the user. Meanwhile, unclicked results, such as newly added results, that may be relevant to the search query may nevertheless languish at the bottom of the list due to their relatively low visibility.

Moreover, outliers may exist within any data set. To this end, outlier results, which may have relatively little relevance to the search query, may still receive some actual clicks and be deemed relevant. For instance, in the case of image search queries, images showing attractive and/or famous persons may receive some actual clicks despite having no relevance to the search query whatsoever.

Furthermore, the baseline ranker, which determines each result's original relevancy score, may itself provide flawed original relevancy scores. For instance, consider again the search query “night train” in which the baseline ranker gives high original relevancy scores to results that are not associated with motorcycles. As mentioned above, most users who submitted the “night train” search query may have in fact intended to search for results related to a particular brand of motorcycles. Thus, in similar scenarios, the most relevant search results may not receive the best original relevancy scores, and at worst, irrelevant search results may receive relatively high original relevancy scores.

At step 240, the search application 60 may determine the click relevancy score for each result using the predicted number of clicks estimated in step 230 and the original relevancy score. In general, the click relevancy score for a search result may be based in part on determining the predicted number of clicks the result is expected to receive. As such, steps 230 and 240 may be highly related, and in one implementation, the click relevancy score for a result x may be calculated using the following equation:

s_{R}(x)=a₁s_{O}(x)+a₂ y_{Text}(x)+a₃ yᵥᵢₛᵤₐₗ(x) Equation 1

Under this equation, s_{R} may represent the click relevancy score while sₒ may represent the original relevancy score. y_{Text} and yᵥᵢₛᵤₐₗ may represent the predicted number of clicks estimated using textual and visual features, respectively, derived from the result x, its associated parent document, and/or other metadata.

As shown above, separate estimates of predicted clicks may be calculated according to a result's textual features and visual features. Using separate estimates may enable similarities in a particular domain (e.g., a textual or visual domain) to be captured in at least one of the estimates. For example, in the case of image results, if two images are relatively similar to each other but their parent documents are relatively different, the predicted click estimates for the two images may be relatively similar for the visual features and relatively dissimilar for the textual features.

In addition, a₁, a₂ and a₃ may be global weighting constants derived from experimentation with validation sets. For example, consider a set of 10 search queries for which the correct ranking of results corresponding to each query is known. The set of queries, along with each query's ranked list of results, may be considered a validation set. Then, all possible combination of values of global weighing constants a₁, a₂ and a₃ may be substituted for Equation 1. The values for a₁, a₂ and a₃ may then be selected according to the combination for which Equation 1 returns results that most closely matches the rankings in the validation set. In one implementation, a₁ may be 0.7, a₂ may be 0.2, and a₃ may be 0.1.

As may be evident from Equation 1, the click relevancy score for a result may be derived from a linear combination of the original relevancy score s_{O} and the predicted number of clicks for the result according to both textual and visual features y_{Text} and y_{Visual}. In particular, the click relevancy score may depend in part on calculating y_{Text} and y_{Visual}. Generally, y_{Text} and y_{Visual} may be determined by comparing the similarity between the features (textual and visual) of the result x and the features of the clicked results. In one implementation, the similarity may be expressed as a real number between 0 and 1 to provide a weight against the set of clicked data. For example, if an unclicked result is deemed to be relatively half as similar to a clicked result, the similarity may be expressed as a real number near 0.5. Consequently, the estimated number of predicted clicks for the unclicked result may be approximately half the actual number of clicks the clicked result has received. As such, the set of clicked results may be referred to as a training set, since clicked results may be used to provide the estimated clicks for the unclicked results.

To this end, y_{Text} and y_{Visual} may be calculated using regression analysis on the textual and visual features of result x, and more particularly, using Gaussian Process Regression given by the following equation:

y(f)=k(f, f_{Train}) [k(f_{Train}, f_{Train})+σ²l]⁻¹y_{Train} Equation 2

Under this equation, y may represent the predicted number of clicks, and y_{Train} may be a vector representing the number of actual clicks recorded for each clicked result in the training set. f may be a vector representing the features extracted from a result x, and f_{Train} may be a vector representing the corresponding features from the training data set of clicked results. k may represent a kernel function, in this case Gaussian, such that k(fᵢ, fⱼ)=exp(−γ|fᵢ−fⱼ|²). k may compare the similarity between the features fᵢ and fⱼ extracted from any given pairs of results, parent documents and meta-data sets. As illustrated by Equation 2, the kernel function may provide a weight against the number of actual clicks for the training set. σ may represent a noise parameter.

Additionally, in order to provide an accurate estimation using regression analysis, the cardinality of a training data set should exceed the number of model parameters to be estimated. In other words, the number of clicked results in the training set (i.e., the number of clicked results represented by y_{Train}) should exceed the number of features that are being compared (i.e., the number of features represented by f_{Train}). For a given search query, however, the number of clicked results may typically remain relatively low at around 20-100 results, while the number of features may exceed several thousand. Therefore, various technologies described herein may contemplate performing a dimensionality reduction algorithm to reduce the number of features to match the number of clicked results in the training set. In one implementation, Principal Component Analysis may be used to reduce and select the features f before performing the regression analysis in Equation 2.

It should be noted that other dimensionality reduction algorithms are also contemplated, such as average click rank, correlation with original relevancy scores, and/or correlation with actual number of clicks. Furthermore, other types of regression algorithms may be used to determine the predicted number of clicks for each search result, such as linear regression, support vector regression, nearest neighbour, and the like. Still further, different supervised learning techniques other than regression may be used to determine the predicted number of clicks, such as classification, ordinal regression, ranking, or the like.

At step 250, the search application 60 may re-rank the search results according to their click relevancy scores. In one implementation, the click relevancy score may be a real number such that a greater number may signify a greater relevancy to a search query. Finally, in step 260 the search results may be displayed to the user in their re-ranked order.

Furthermore, while method 200 has been described with reference to a single search application 60 performing the steps, it should be understood that in some implementations multiple applications may perform these steps as well. For example, a first application may provide the baseline ranking algorithm to determine the search results' original relevancy scores, while a second application may determine the click relevancy scores.

As mentioned above, various technologies described herein may be applied to image search queries since user clicks for image results may be particularly highly correlated their relevance. This may be because users may see the entire images as thumbnails, which may provide more information than the textual summaries associated with textual search results. Users may therefore be more likely to click on images relevant to them. However, various technologies described herein are not limited to image search queries and may be applied to various other types of search queries including, but not limited to, text search queries and/or video search queries.

Various technologies described herein for providing search results may have an advantage of being query-specific since each result may be ranked according to an estimated number of clicks it has received in response to a particular query. As previously mentioned, a result's number of clicks may be highly correlated to its relevancy to the corresponding search query. Consequently, various technologies described herein may generally increase the relevancy of search results to user search queries.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing search results in response to a search query, comprising:
receiving the search query from a user;
generating a plurality of results in response to the search query, wherein the plurality of results is ranked according to an original relevancy score;
generating a click relevancy score for each result, wherein the click relevancy score is based on a number of clicks each result is expected to receive;
re-ranking the plurality of results according to the click relevancy score; and
presenting the plurality of results according to the click relevancy score.

2. The method of claim 1, wherein the plurality of results is presented in order of decreasing relevancy.

3. The method of claim 1, further comprising determining the original relevancy score via a baseline ranker.

4. The method of claim 1, wherein the search query is an image search query.

5. The method of claim 1, wherein the plurality of results comprises one or more clicked results that have received clicks in the past in response to the search query

6. The method of claim 5, wherein generating the click relevancy score for each result comprises estimating a predicted number of clicks for each result.

7. The method of claim 6, wherein estimating the predicted number of clicks comprises selecting one or more features that are associated with each result according to a dimensionality reduction algorithm.

8. The method of claim 7, wherein the dimensionality reduction algorithm is Principal Component Analysis.

9. The method of claim 7, wherein the features comprise textual features, visual features or combinations thereof.

10. The method of claim 9, wherein estimating the predicted number of clicks further comprises performing a regression analysis to compare a similarity between the features of each result with the features of the one or more clicked results.

11. The method of claim 10, wherein performing the regression analysis comprises performing a Gaussian Process Regression.

12. The method of claim 9 wherein the click relevancy score for each result is determined by the equation s_{R}(x)=a₁ s_{O}(x)+a₂ y_{Text}(x)+a₃ y_{Visual}(x), wherein x represents each result, s_{R} represents the click relevancy score, s_{O} represents the original relevancy score, y_{Text} represents the predicted number of clicks using textual features of each result, y_{Visual} represents the predicted number of clicks using visual features of each result, and a₁, a₂ and a₃ represent global weighting constants.

13. The method of claim 9, wherein the predicted number of clicks for each result is estimated using the equation y(f)=k(f, f_{Train}) [k(f_{Train}, f_{Train})+σ²l]⁻¹ y_{Train}, wherein y represents the predicted number of clicks, y_{Train} is a vector representing a number of actual clicks recorded for each clicked result, f is a vector representing the one or more features that are associated with each result, f_{Train} is a vector representing one or more features that are associated with each clicked result, k represents a kernel function such that k(fᵢ, fⱼ)=exp(−γ|fᵢ−fⱼ|²), and σ is a noise parameter.

14. A computer-readable storage medium having stored thereon computer-executable instructions which, when executed by a computer, cause the computer to:
receive a search query from a user;
generate a plurality of results in response to the search query, each result having a plurality of features;
rank the plurality of results according to an original relevancy score determined by a baseline ranker;
generate a click relevancy score for each result, wherein the click relevancy score is based on a number of clicks each result is expected to receive;
re-rank the plurality of results according to the click relevancy score; and
present the plurality of results according to the click relevancy score.

15. The computer-readable storage medium of claim 14, wherein the plurality of results comprises one or more clicked results that have received clicks in the past in response to the search query.

16. The computer-readable storage medium of claim 15, wherein the computer-executable instructions to generate a click relevancy score for each result comprises computer-executable instructions which, when executed by a computer, cause the computer to:
select one or more features that are associated with each result according to a dimensionality reduction algorithm; and
perform a regression analysis comparing the similarity between the features of each result with the features of the clicked results.

17. A computer system, comprising:
at least one processor; and
a memory comprising program instructions that when executed by the at least one processor, cause the at least one processor to:
receive an image search query from a user;
generate a plurality of image results in response to the image search query, the each image result having one or more features;
rank the plurality of image results according to an original relevancy score determined by a baseline ranker;
perform a regression analysis to compare a similarity between the features of each image result with the features of one or more clicked image results to estimate a predicted number of clicks for each image result;
combine the predicted number of clicks with the original relevancy score to generate a click relevancy score for each image result;
re-rank the plurality of image results according to the click relevancy score; and
present the plurality of results according to the click relevancy score.

18. The computer system of claim 17, wherein the regression analysis is Gaussian Process Regression.

19. The computer system of claim 17, wherein the memory further comprises program instructions configured to select the features of each image result according to a dimensionality reduction algorithm.

20. The computer system of claim 17, wherein the features comprise textual features, visual features or combinations thereof.
